(19) United States
(12) Patent Application Publication
(10) Pub. No.: US 2025/0141857 A1
(43) Pub. Date: May 1, 2025

(54) System and Method for Detecting and Verifying A.I.-Generated Material

(71) Applicant: CatchGPT Inc, Mountain View, CA (US)

(72) Inventors: Alvin B Lu, Mountain View, CA (US); Nicholas A. Guerrero, Austin, TX (US); Percy A. Wong, Orange, CA (US); Andrew J. Thompson, McKinney, TX (US); Lee J. Lorenzen, Pacific Grove, CA (US)

(21) Appl. No.: 18/495,053

(22) Filed: Oct. 26, 2023

(51) Int. Cl. H04L 9/40; G06F 40/20; G06F 40/30

(52) U.S. Cl. CPC H04L 63/08; G06F 40/20; G06F 40/30

(57) ABSTRACT

A method for detecting and verifying A.I.-generated material, said method comprising the steps of: receiving a submitted material; analyzing the received material for attributes characteristic of at least one of an A.I.-generated material or human-generated material; scoring the analyzed material for a detection score; flagging the scored material above a pre-defined detection score; prompting a verification request for at least one submission of a response to at least one of a question or task; analyzing said response material by referencing against the submitted material for a verification score; and verifying the authenticity of the submitted material based on the verification score.

### FIELD OF INVENTION

The invention pertains generally to the field of Artificial Intelligence (A.I.) detection, and more particularly, to an automated verification channel to ensure original authorship of a submitted material.

### BACKGROUND OF INVENTION

On rare occasion, a tool is developed that immediately captures the collective imagination—touting its transformative reach across industries and domains. Industries are clamoring to exploit A.I tools to automate and enhance their content creation. Content may range from enterprise-level workflows, reports/presentations, written publications, digital exchanges, social media posts, episodic/film scripts, works of art, musical compositions, and academic assignments, etc. While the consuming public has long had exposure to A.I.—from asking questions to Siri; to ordering items on Amazon Prime using Alexa—we have now just entered the realm of A.I.-enhanced digital content creation. Generative AI tools, like ChatGPT, utilize neural network methodologies to understand and interpret input data and then produce contextually relevant outputs. These tools can create prompted images, videos, music, text, and various other creative content based on the interpreted input data from reinforced learning and training.

In this new age of A.I.-enhanced content creation, concerns over original authorship and content integrity are paramount. This is especially evident in the field of academia, where writing proficiency is at the heart of the academic exercise. To that end, academic institutions—in an effort to stay one step ahead of the student—have implemented commercially available A.I. detectors to combat the growing use of A.I. for assignments. These detectors essentially function based on extensive pattern recognition. Unfortunately, this approach also inadvertently flags legitimate student submissions, resulting in an overwhelming number of false positives. The significant challenge here is the absence of a follow-up verification mechanism after flagging. Thus, educational institutions find themselves swamped, having to discern the authenticity of content manually and risking the potential oversight of genuine submissions. There is a need for a detection and verification solution that solves both problems: avoiding false positives and providing a seamless and frictionless verification procedure.

### SUMMARY

These and other features and improvements of the present application will become apparent to one of ordinary skill in the art upon review of the following detailed description when taken in conjunction with the several drawings and the appended claims. This invention relates to the detection and verification of A.I.-usage for any material submitted, wherein creator authenticity and integrity are paramount. In contrast to other A.I.-generated detectors, the present invention teaches for a detection model that yields less false positives, in addition to featuring an automated verification prompt to further verify flagged material. Both the detection and verification segments of the Detection/Verification pipeline (D/V) employ a general-use large language model (LLM) configured to automate a prompt for determining a quantitative or qualitative likelihood of the submitted material being either human or A.I.-generated. The prompt may feature at least the material, as submitted by the creator of the material, and its binary classifier output, along with prompt instructions to determine a likelihood of human or A.I. generation. Once flagged, the verification segment of the D/V pipeline may automate a request for a response from the creator, and based on said response material and initial prompt results, populate a second LLM prompt to determine likelihood of the human or A.I. generation

In one exemplary aspect, a method is introduced for detecting and verifying A.I.-generated content. Upon receiving submitted material, it undergoes an analysis to identify attributes characteristic of either A.I.-generated or human-generated content. The analysis can include at least running the submitted material through a purpose-built, pre-trained binary classifier for prompting a large language model to determine a risk or likelihood of being A.I.-generated material. If the material scores above a pre-defined detection threshold, it's flagged for further verification. Verification may include at least automating a prompt requesting a response from the author under suspicion. The request may be for a response to a curated question or task probative of authenticity regarding the submitted material. The response material may then serve as an additional input, along with the inputs from the first LLM prompt, into a second LLM prompt for determining the likelihood of human or A.I. generation with respect to the submitted material.

In another aspect, a sentiment analysis may be incorporated into the detection phase to determine if the submitted material is fiction or non-fiction, and as a result, route the submitted material to a pre-trained fiction or non-fiction binary classifier for a more fine-tuned output.

In yet another aspect, the system is programmed to handle tasks from receiving and analyzing content to verifying its authenticity based on a score. The system provides a user interface, displaying attributes of the analyzed content, risk scores, and verification status. This interactive dashboard allows users to review the authenticity determination manually and even override the system's decision if they see fit. Additionally, users can provide feedback on the accuracy of the detection and/or verification process, contributing to system improvement.

Further yet, in another aspect, an update module, driven by reinforcement learning, continuously refines the database. This module detects new patterns from A.I.-generated content and learns from feedback on human-authored pieces, optimizing the verification process. The system is also equipped with a feedback loop, encouraging users to report perceived biases and ensure fairness.

In another embodiment, the system introduces a remote proctoring module, initiating real-time video capture of users during a response crafting phase. The purpose is to further verify the validity of the flag and the authenticity of submitted material. Both the original and proctored response are presented side-by-side for a comparative study.

In a different approach, the system offers non-proctored verification. Here, content is analyzed based on distinct attribute characteristics and then verified. Cross-referencing metadata, like timestamps and IP addresses, is also employed for added verification. Finally, there's an embodiment focusing on the certification of authenticity. Once content passes verification, it may be assigned a unique certification token. This token is then recorded on a digital ledger, ensuring its immutability. Entities can then exchange or reference this token, vouching for the content's authenticity.

Further advantages and novel features of the invention will be set forth in part in the description that follows, and in part will become more apparent to those skilled in the art upon examination of the following or upon learning by practice of the invention.

### BRIEF DESCRIPTION OF FIGURES

The drawings illustrate the design and utility of embodiments of the present invention, in which similar elements are referred to by common reference numerals. In order to better appreciate the advantages and objects of the embodiments of the present invention, reference should be made to the accompanying drawings that illustrate these embodiments. However, the drawings depict only some embodiments of the invention, and should not be taken as limiting its scope. With this caveat, embodiments of the invention will be described and explained with additional specificity and detail through the use of the accompanying drawings in which:

[1] FIG. 1A depicts an exemplary network diagram in accordance with an aspect of the invention.

[2] FIG. 1B depicts an exemplary system block diagram in accordance with an aspect of the invention.

[3] FIG. 2 depicts an exemplary method flow diagram in accordance with an aspect of the invention.

[4] FIG. 3 depicts an exemplary method flow diagram in accordance with an aspect of the invention.

[5] FIG. 4 depicts an exemplary interaction flow diagram in accordance with an aspect of the invention.

[6] FIG. 5 depicts an exemplary interaction flow diagram in accordance with an aspect of the invention.

[7] FIG. 6 depicts an exemplary process flow diagram in accordance with an aspect of the invention.

[8] FIG. 7 depicts an exemplary process flow diagram in accordance with an aspect of the invention.

[9] FIG. 8 depicts an exemplary process flow diagram in accordance with an aspect of the invention.

FIG. 9 depicts an exemplary process flow diagram in accordance with an aspect of the invention.

FIG. 10 depicts an exemplary user interface in accordance with an aspect of the invention.

FIG. 11 depicts an exemplary user interface in accordance with an aspect of the invention.

FIG. 12 depicts an exemplary user interface in accordance with an aspect of the invention.

FIG. 13 depicts an exemplary user interface in accordance with an aspect of the invention.

### DETAILED DESCRIPTION

Numerous embodiments of the invention will now be described in detail with reference to the accompanying figures. The following description of the embodiments of the invention is not intended to limit the invention to these embodiments but rather to enable a person skilled in the art to make and use this invention. Variations, configurations, implementations, and applications described herein are optional and not exclusive to the variations, configurations, implementations, and applications they describe. The invention described herein can include any and all permutations of these variations, configurations, implementations, and applications. In the following description, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

### EXEMPLARY ENVIRONMENT

FIG. 1A illustrates a network diagram of the detection/verification pipeline or system (D/V). The networked environment includes the D/V engine 130, a large language model 120, and a user 140. The D/V engine 130, the large language model 120, and the user 140 are communicatively coupled through a network 110.

In an exemplary embodiment, the network 110 facilitates communication between modules, namely the D/V engine 130, and networked entities to verify authenticity of author-submitted material. An intuitive UX/UI system allows users to navigate the graphical and informational layers. This system provides a quick and efficient way to verify author-submitted authenticity, eliminating false positives and wrongful expulsions, suitable for users 140 whereby academic or creative integrity are at the forefront-students, academic institutions, hiring coordinators, professional associations, publishers, news agencies, social media moderators, etc.

In continuing reference to FIG. 1A, the network 110 may be any suitable wired network, wireless network, a combination of these or any other conventional network, without limiting the scope of the present invention. Few examples may include a LAN or wireless LAN connection, an Internet connection, a point-to-point connection, or other network connection and combinations thereof. The network 110 may be any other type of network that is capable of transmitting or receiving data to/from host computers, personal devices, mobile phone applications, video/image capturing devices, video/image servers, or any other electronic devices. Further, the network 110 is capable of transmitting/sending data between the mentioned devices. Additionally, the network 110 may be a local, regional, or global communication network, for example, an enterprise telecommunication network, the Internet, a global mobile communication network, or any combination of similar networks. The network 110 may be a combination of an enterprise network (or the Internet) and a cellular network, in which case, suitable systems and methods are employed to seamlessly communicate between the two networks. In such cases, a mobile switching gateway may be utilized to communicate with a computer network gateway to pass data between the two networks. The network 110 may include any software, hardware, or computer applications that can provide a medium to exchange signals or data in any of the formats known in the art, related art, or developed later.

In further reference to FIG. 1A, the large language model 120 or generative model is a neural network based on transformer architecture that is pre-trained on large datasets of unlabeled text and capable of generating novel human-like text, speech, and visual content. Examples include, but not limited to, LLM, text-to-music, text-to-voice, text-to-image, such as GTP-4, BERT, ELMo, and DALL-E. It is important to note that the large language model or generative model may also include for additional functionalities and applications beyond content generation. These can range from language translation, sentiment analysis, and question-answering to more advanced tasks like code generation, data summarization, and content recommendation. Moreover, while the discussion here centers on large language models, it's essential to recognize that the detection and verification (D/V) pipeline is not limited to these models alone. Instead, this pipeline can be readily extended to a multitude of general-purpose models. This includes those focused on image, audio, video, and more. Essentially, any domain where patterns can be discerned and learned from, these models can be adapted to detect and verify human or A.I. generation.

Now in reference to FIGS. 1B and 2, which depicts an exemplary system block diagram of the D/V Engine 130 and an exemplary method flow diagram of the D/V pipeline, respectively. In one embodiment, the detection module 132 is configured to receive a submitted material; analyze the received material for attributes characteristic of at least one of an A.I.-generated material or human-generated material 202; score the analyzed material for a detection score; flag the scored material above a pre-defined detection score; and prompt a verification request for at least one submission of a response to at least one of a question or task 204. The verification module 134, on the other hand, then analyzes said response material to deduce a verification score; and finally verifies the authenticity of the submitted material based on the verification score 206.

FIG. 3 illustrate exemplary method flow diagrams for the D/V pipeline in accordance with an aspect of the invention. In contrast to FIG. 2, FIG. 3 details a method for deducing a verification of a flagged material based on a non-proctored approach, entailing the steps of: analyzing the received material for attributes characteristics of at least one of A.I.-generated material or human and scoring the analyzed material 302; flagging the scored material above a pre-defined score and prompting a verification request 304; and verifying the authenticity of the flagged material based on analysis of at least a second attribute characteristic for deriving a verification score 306. A.I. generated material may comprise certain metadata or a digital signature, such as a cryptographic hash or token, for instance, that indicates any one of origin, date of creation or modification, or even the platform or model the content was created on. For images and audio, a frequency analysis can reveal patterns typical of AI generation. For example, AI-generated images might have certain artifacts or characteristics in their frequency domain that aren't present in human-generated images or audio. The advantage of this verification approach is that it avoids an administrator needing to notify or involve the suspected cheater. The D/V pipeline could detect, flag, and verify without requiring cooperation (proctored response to the automated verification prompt) from the content submitter. By combining both primary attributes (like structure and syntax patterns) and secondary attributes (like metadata or digital signatures), a more robust and comprehensive verification system can be established

FIGS. 4 and 5 each illustrate exemplary interaction flows of the D/V pipeline, featuring a detection interaction and verification interaction, respectively. As a high-level abstraction, the detection paradigm depicted in FIG. 4 entails receiving the submitted material and representing as a vector in. a pre-defined vector space using word-to-integer mapping to be fed into a binary or multi-classifier that is pre-trained on labeled data. The output of which is then fed into an LLM (optionally, any generative model) prompt, as at least one input, along with an instructional prompt for determining a likelihood of being A.I.-generated or human generated. In one embodiment, the likelihood of A.I. or human is expressed in a score-like fashion, wherein a risk score above a pre-defined threshold indicates an authentic authorship status.

The verification model in FIG. 5 leverages a mix of question types to robustly assess the genuineness of the content. Knowledge-based questions seek to test the foundational understanding and contextual awareness of the content's author. Evidence-based questions, on the other hand, request specific citations, references, or tangible proof supporting the content's assertions. Lastly, writing-based tasks may involve the author reproducing specific styles, tones, or nuances in their content, ensuring consistent linguistic patterns between the original submission and the prompted response.

Upon completion of the verification question(s) or task(s), the combined data—comprising the original submission, the analyzed text from the detection phase, the response from the verification tasks, and the instructional prompt for verifying the detected risk—are fed into the generative model. This model then calculates a verification score, verifying the likelihood that the flagged content is in fact A.I.-generated.

When a submitted material is flagged during the initial detection phase, it triggers a subsequent verification process. This verification step is crucial for enhancing the confidence level in the initial flagging. The verification process involves soliciting a response, which is then subjected to the same detection procedure. The objective is to generate a likelihood score indicating whether the response is AI-generated or not.

During this verification process, a perplexity analysis or score is performed on the responses. Perplexity essentially measures the level of entropy or regularity in the text, providing insights into how coherent or predictable the content is. The responses from the Verification module are rerun through the Detection module, where a generative model or a purpose-trained classifier comes into play.

This classifier examines various aspects, including the perplexity (regularity score) of the text, binary classification indicating AI generation, and the style of writing. These factors are evaluated both in the original submission and the verification response.

The outcome of this evaluation leads to one of three potential results:

Failed: In this case, the verification response does not align with the original submission, indicating a lack of consistency or authenticity.

Flagged: The response matches the original submission to some extent, but there are significant differences in risk scores between the two. This outcome prompts a second round of verification, highlighting potential discrepancies.

Pass: When the response aligns closely with the original submission, and the risk scores match between the two, it signifies a successful verification process. This indicates that the response is likely not AI-generated and is consistent with the submitted material.

FIGS. 6-9 each represent an exemplary D/V flow schematic. FIG. 6 illustrates an exemplary detection flow in accordance with an aspect of the invention. The process begins with the first step, where a submitted material is received. This material may be in various formats, including text, image, video, audio, or numerals, and the system is capable of adapting its analysis to different types of material. The next step involves semantic analysis, wherein the system categorizes the submitted material as either fiction or non-fiction. For example, if the material is determined to be fiction, it is directed to a fiction binary classifier that has been pre-trained and purpose-built for fiction categorization. Similarly, if the material is categorized as non-fiction, it is directed to a non-fiction binary classifier designed for that specific purpose.

Details of the pre-training of these binary classifiers may involve training on extensive datasets containing examples of fiction and non-fiction content. The classifiers may be multi-faceted, adaptable to various end-use applications, and optimized for accuracy. After classification, the submitted material is then subjected to a binary classifier that determines the likelihood of it being generated by a human or an AI. The choice of binary classifier depends on the categorization made in the earlier step (fiction or non-fiction).

All relevant inputs, including the submitted material, sentiment analysis, binary classifier output (likelihood of human or AI generation), are then combined to form a generative model prompt. This prompt is typically based on a large language model (LLM) or generative model and includes instructions such as “determine the likelihood of being AI-generated or human-generated.” The generative model processes these inputs and generates a risk score or detection score. If this score surpasses a predefined threshold, the material is flagged as potentially AI-generated. Flagging indicates that the system has detected attributes in the material that suggest AI generation, warranting further verification.

It's worth noting that this detection pipeline can be adapted or modified to accommodate different numbers and types of inputs based on the specific use case and material type. However, at a minimum, the material passes through a classifier and is then subjected to analysis by a generative model. This adaptable approach ensures that the system can effectively detect AI-generated content in various contexts and formats.

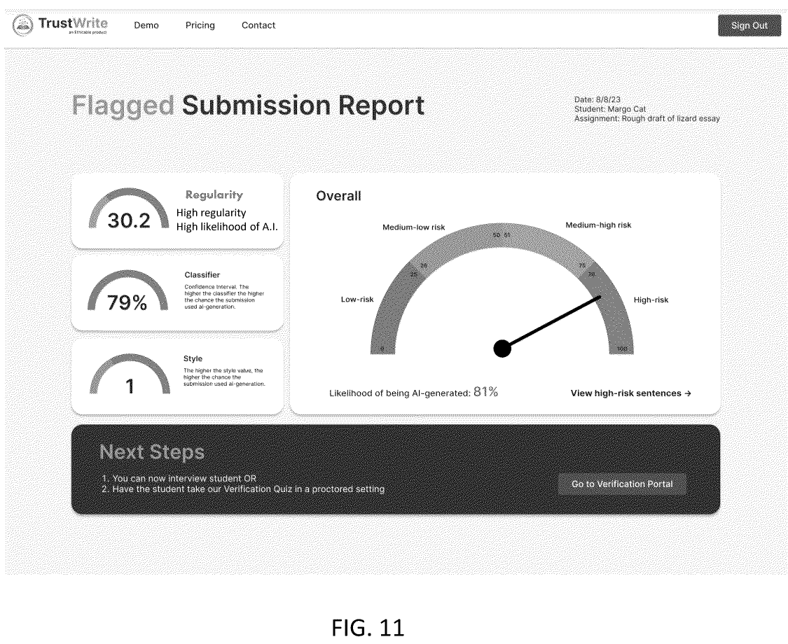

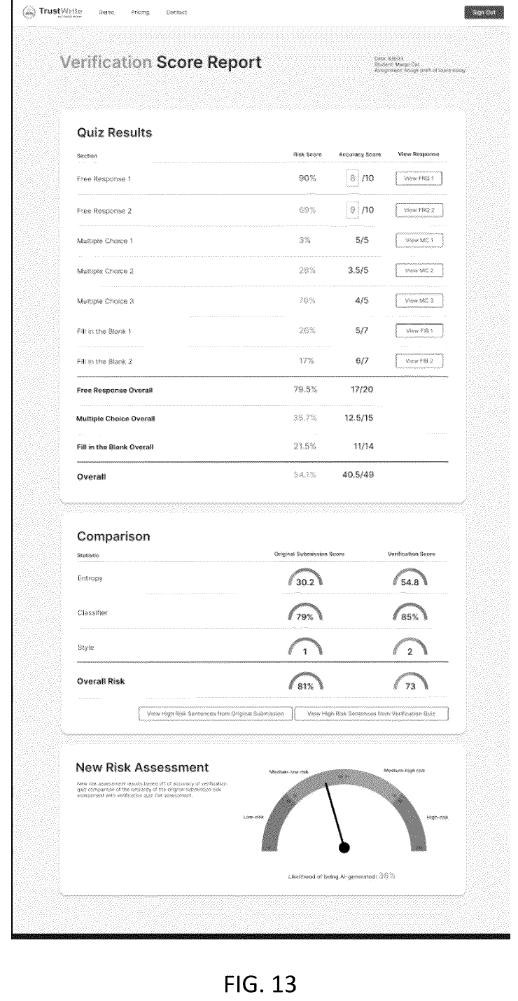

FIG. 8 illustrates an enhanced detection flow that incorporates perplexity analysis as an additional input into the detection process. The flow largely mirrors the steps outlined in FIG. 6 but includes the critical addition of perplexity analysis (regularity or entropy score, as indicated in FIGS. 11 and 13). As in FIG. 6, the process begins with the receipt of submitted material, which can be of various types. However, in this enhanced flow, a perplexity analysis is performed on the submitted material to derive a perplexity score. This perplexity analysis evaluates the linguistic complexity and coherence of the content. If the perplexity score is above a predefined threshold, it adds to the confidence in the detection process.

The material is then categorized as fiction or non-fiction through semantic analysis, allowing the system to apply the appropriate binary classifier tailored to the content type. Following classification, the material proceeds to the binary classifier, which determines the likelihood of it being created by a human or AI. This binary classifier may be different for fiction and non-fiction, depending on the earlier categorization. The perplexity score, in addition to the other inputs such as sentiment analysis and binary classifier output, is incorporated into the generative model prompt. The prompt instructs the generative model, which can be a large language model (LLM) or similar technology, to assess the likelihood of the material being AI-generated or human-generated. The generative model processes these inputs and produces a risk score or detection score. If this score exceeds a predefined threshold, the material is flagged as potentially AI-generated, indicating that attributes in the content suggest AI generation.

This enhanced detection flow emphasizes the importance of perplexity analysis in bolstering the system's ability to detect AI-generated content accurately. By considering linguistic complexity alongside other factors, the system enhances its confidence in flagging potentially AI-generated material, thereby improving the overall accuracy of the detection process.

In an embodiment illustrated in FIG. 7, the verification phase within the Detection and Verification (D/V) pipeline serves as a redundancy mechanism designed to validate and enhance the confidence level of the initial detection or flagging process. As in the preceding detection phase described in FIG. 6, the verification process incorporates various inputs into the generative model, and the inclusion of additional inputs augments the level of verification confidence. Initiating this verification process involves prompting the author of the flagged material. The author is presented with a series of questions or tasks specifically formulated and curated to elicit a response, thereby substantiating the human origin of the content under scrutiny.

The author's response to these inquiries constitutes a pivotal element of the verification process. Subsequently, the response undergoes further analysis. In the subsequent phase, the author's response is input into the generative model, which operates under explicit instructions to assess the likelihood that the flagged material, referred to as the original submission, is indeed AI-generated. The generative model, mirroring the detection phase, meticulously considers both the flagged material and the author's response in its evaluation. The output of this verification phase encompasses three potential outcomes, further delineating the verification status.

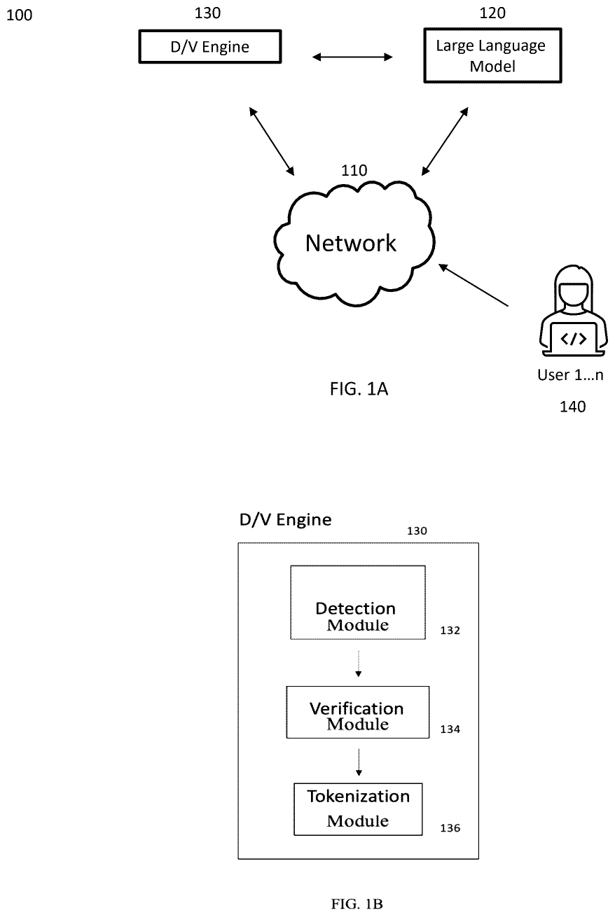

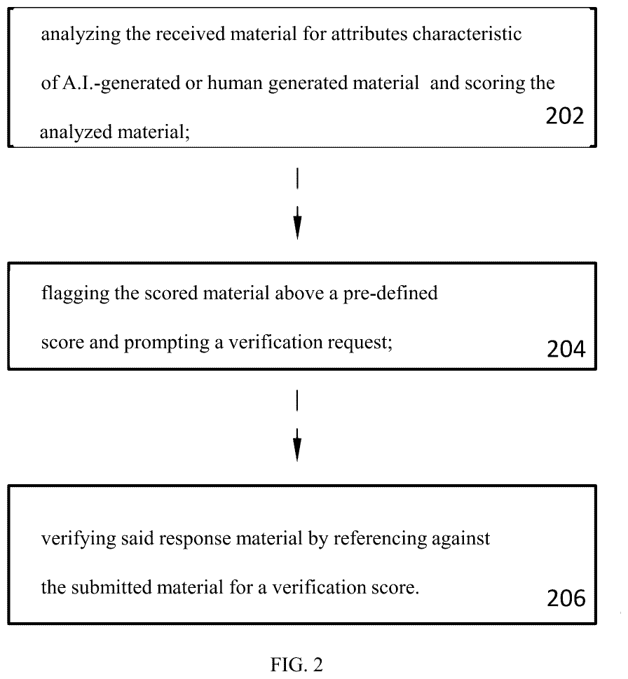

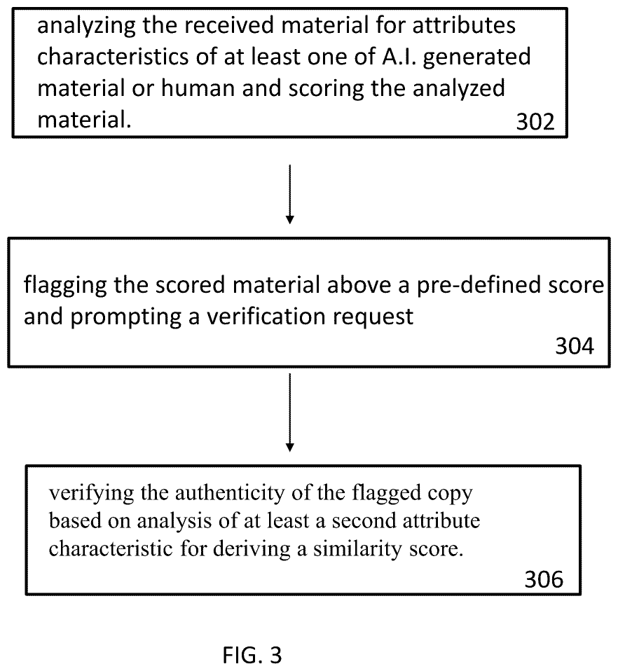

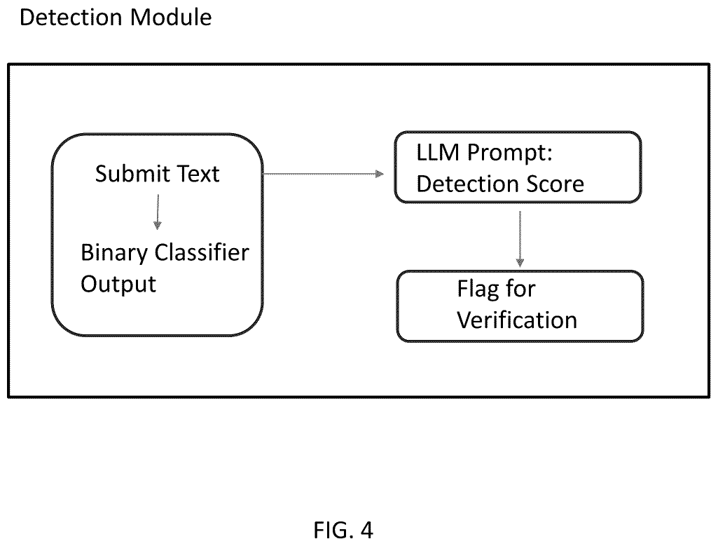

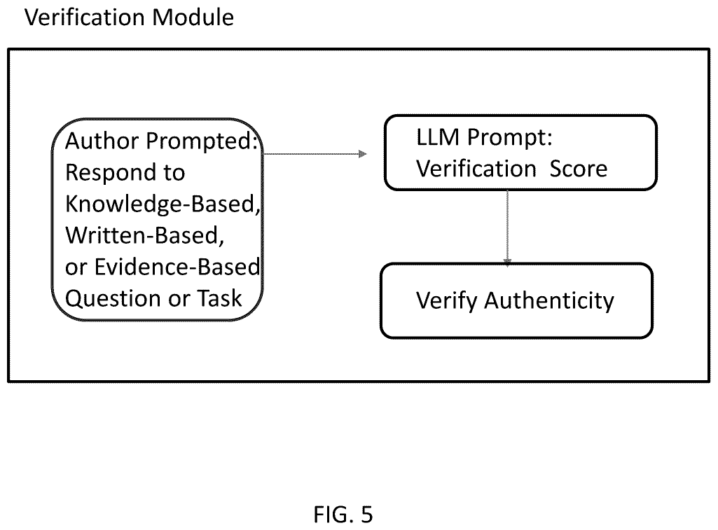

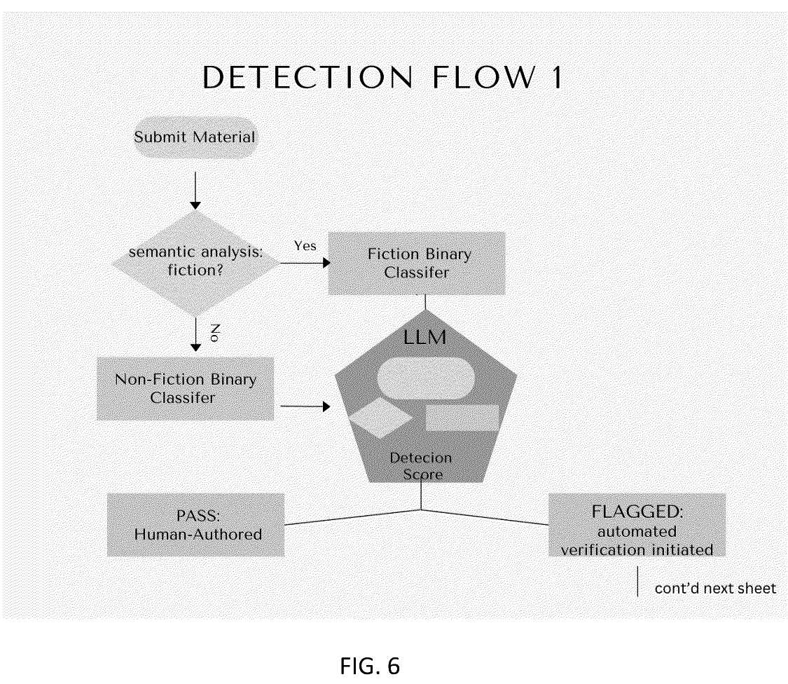

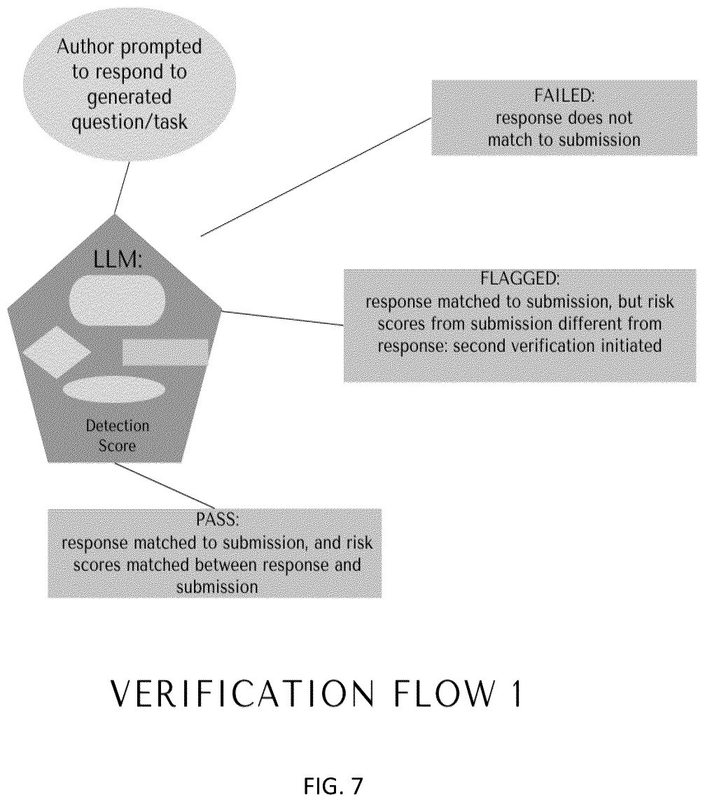

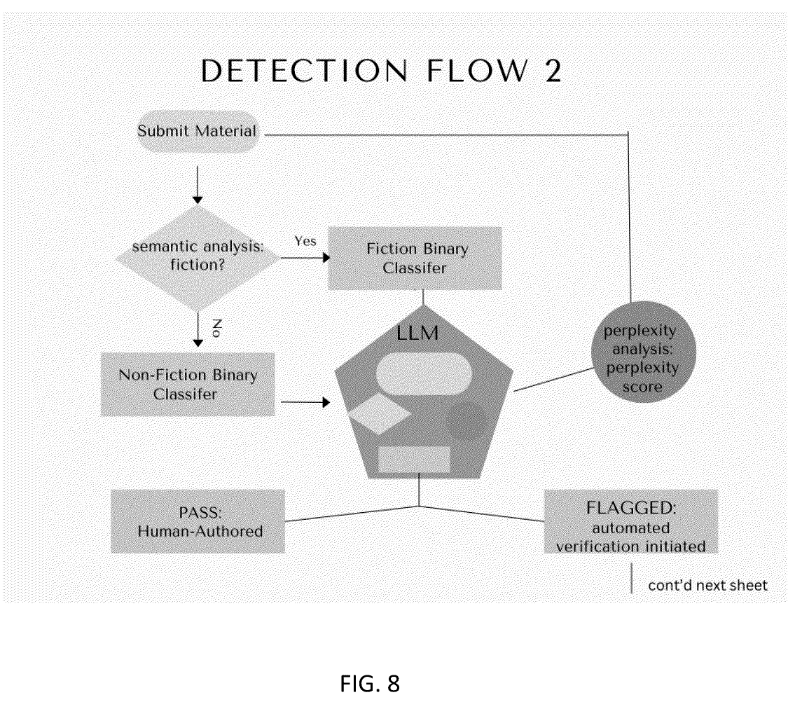

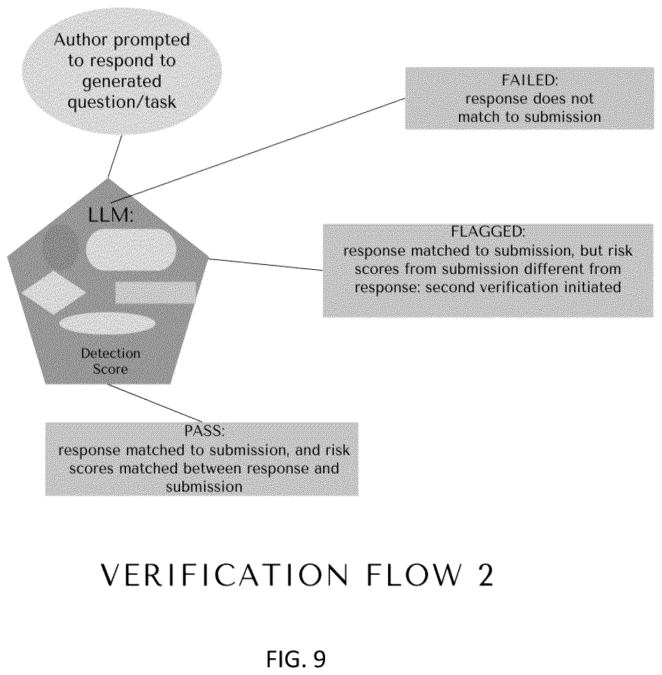

FIG. 9 introduces an enhanced verification flow that integrates perplexity analysis into the verification process to fortify and enhance the confidence level of our verification results. This augmentation builds upon the detection steps delineated in FIG. 8. In an embodiment, the verification process commences with the flagged material, signifying the output of the initial detection phase. However, FIG. 9 introduces an additional layer of scrutiny, perplexity analysis, which assesses the linguistic complexity and coherence of both the original submitted material and the author's response.

### Exemplary User Scenarios:

### Scenario 1: Academic Integrity—Institutional Perspective

Jake, a diligent student facing the pressures of senior year and personal challenges, finds himself at a crossroads. Driven by the allure of ChatGPT, an advanced AI renowned for crafting human-like text, he rationalizes using it for a single assignment. Jake embarks on this academic shortcut by visiting the ChatGPT website. He inputs the assignment's topic and receives an impeccably structured essay in return, replete with sophistication and logical coherence. Bolstered by the belief that his submission is both original and impervious to plagiarism checks, he proceeds to submit it. However, Jake's university employs TurnItIn, a widely-used plagiarism checker aimed at preserving academic integrity. While TurnItIn may not flag direct plagiarism in the AI-generated essay, its advanced algorithms discern an anomalous writing style and pattern that diverge from Jake's previous submissions.

This divergence leads to an unexpected outcome: a warning generated by TurnItIn, signifying an incongruity in writing style and structure. Although direct plagiarism remains undetected, the suspicion surrounding the sophistication of the essay and its deviation from Jake's prior work grows. Alarmed by TurnItIn's report, Jake's professor, Mr. Lewis, initiates a comprehensive inquiry. Mr. Lewis engages Jake in a one-on-one interview, delving into specific sections of the essay. As Jake attempts to explain certain arguments and sources, which he purportedly “researched,” he fumbles and stumbles, unable to provide satisfactory explanations.

Confronted with mounting evidence and Jake's inability to defend his work, Mr. Lewis takes the matter to the university's academic integrity board. Following a thorough review and a subsequent hearing, the board arrives at a severe verdict in line with the institution's zero-tolerance policy on cheating. The consequence is dire: Jake faces expulsion from the university, shattering his aspirations of graduation and pursuing a master's program. This outcome stands as a stark reminder of the paramount importance of upholding academic integrity and the potential perils associated with seeking shortcuts.

This narrative serves as a poignant cautionary tale, highlighting the real-world repercussions of attempting to circumvent academic standards. While AI tools continue to advance, educational institutions and their associated tools are also evolving to detect anomalies and uphold the sanctity of academic work.

### Scenario 2: Academic Integrity—Student Perspective

Alex is known for his commitment to originality and his propensity to invest extensive hours in research, brainstorming, and diligent writing. On one evening, he immerses himself in crafting an essay on a topic close to his heart, confident that his hard work will shine through. After multiple iterations and meticulous self-reviews, Alex proudly submits his well-crafted essay via the university's online portal. Unbeknownst to him, his unwavering dedication and remarkable improvement over the years have inadvertently led to a paper that stands out.

The university relies on TrustWrite.ai, a sophisticated system dedicated to preserving the integrity of academic submissions. Alex's essay, owing to its exceptional quality and depth, triggers the vigilant AI detection system, initially raising the flag of being “potentially AI-generated.” This development captures the attention of his professor, Ms. Rivera.

Rather than rushing to judgment, TrustWrite.ai initiates a distinctive verification process that places faith in students' integrity. Ms. Rivera, believing in Alex's commitment, leads this process, meticulously designed to assess the authenticity of the work through skill and knowledge-based tasks. Upon being informed of the flag, Alex understandably experiences a moment of concern. However, his apprehension diminishes when he is invited to partake in the verification process. He is presented with a series of tasks, including explaining his thought process behind specific sections of the essay, providing in-depth insights into his sources, and responding to comprehensive questions related to his essay topic.

Alex adeptly navigates the verification tasks, leaving no room for doubt. It becomes unequivocally clear that he not only authored the essay but also possesses an intimate understanding of every facet of his work. Ms. Rivera is astounded by the depth of his knowledge and appreciates TrustWrite.ai's holistic approach, which enables a genuine student to affirm his authenticity. Ms. Rivera offers Alex constructive feedback on his essay, lauding his unwavering commitment and painstaking effort. She commends him for his grace and patience throughout the verification process. Alex not only secures an exemplary grade but also earns newfound admiration and respect from his professor.

This narrative underscores the paramount importance of an all-encompassing system that extends beyond initial detections. Instead, it champions a comprehensive approach that recognizes and celebrates authentic dedication and academic integrity. TrustWrite.ai's verification process stands as a testament to the notion that diligent students like Alex can duly receive recognition for their hard work and commitment.

### Scenario 3: Publishing Integrity

Daniel, eager to make quick money and establish a reputation, stumbles upon the idea of using AI to generate books. With dreams of becoming a ‘bestselling author’ overnight, he uses an AI tool to craft a novel and, feeling confident, claims copyright on the work. Believing that digital platforms might not be stringent with their checks, he submits his first AI-generated novel to Amazon, hoping it'll be one of many. In his mind, hundreds of books equal exponential earnings.

Unknown to Daniel, Amazon has integrated TrustWrite.ai to maintain the integrity of its platform. As the AI system reviews his book, it quickly detects inconsistencies typical of AI-generated content. Instead of immediately rejecting the work, TrustWrite.ai initiates its rigorous verification process. Daniel is informed and is asked to participate in a computer-monitored proctoring process to verify the authenticity of his “creation.” Sitting nervously, Daniel faces a series of tests: Knowledge Test: He's quizzed on intricate details of his own book. Predictably, he struggles to answer questions about the plot, characters, and specific events. Composition Challenge: He's asked to compose a few paragraphs related to a subplot in the book. The result is a stark contrast to the sophisticated prose of the AI. Sentence Identification: Presented with a mix of AI-generated sentences and genuine human-written content, he's asked to distinguish between the two. He's unable to.

Upon failing the verification process, Amazon not only rejects his submission but also flags his account for suspicious activity. Daniel's dreams of becoming a prolific (and deceitful) author are shattered. Word spreads in the author community about Daniel's ill-advised attempt. His reputation takes a severe hit. With the copyright claim proven baseless and the strict terms of service of the platform, he faces potential legal ramifications. Furthermore, Amazon, ever vigilant about its reputation, might ban him from future submissions.

### Scenario 4: Digital Profile Integrity

Emily, an enthusiastic professional, meticulously crafts a thoughtful article within her area of expertise. Bursting with the desire to share her valuable insights, she enthusiastically shares her piece with a wide network of connections on LinkedIn. However, this sudden surge in activity, coupled with the extensive distribution, triggers alarms within LinkedIn's system. The platform, vigilant against bot-generated content and spammy behavior, activates the TrustWrite.ai detection system.

TrustWrite.ai, equipped with advanced algorithms, thoroughly scans Emily's article for patterns commonly associated with AI-generated content. Despite the complexity and quality of Emily's writing, the system categorizes her article as “potentially AI-generated,” though it is genuinely her original work. Rather than hastily labeling Emily's article as spam or automated traffic, TrustWrite.ai initiates a vital verification process. Emily promptly receives a notification about the system's concerns and is invited to substantiate the authenticity of her work.

Emily embarks on the verification journey: Initially, Emily encounters automated questions related to her article. These inquiries delve deep into her topic, prompting her to explain specific points and provide in-depth insights. She's also prompted to compose a brief piece related to her article's topic, allowing for a comparison of writing styles to ensure consistency. Considering the substantial reach of her article and to guarantee absolute accuracy, a human reviewer from LinkedIn's team, guided by prompts from TrustWrite.ai, engages in a dialogue with Emily. They explore the essence of the article, her inspirations, and her writing process.

Emily adeptly navigates through the verification steps, leaving no room for doubt and convincingly demonstrating that the article is indeed her authentic creation. Impressed by her profound knowledge and unwavering commitment to her profession, the human reviewer absolves her article of any suspicions. This journey underscores the significance of combining detection with verification in the contemporary digital landscape. Tools like TrustWrite.ai not only shield platforms from potential liabilities but also ensure that genuine users like Emily do not suffer unjust penalties. The preservation of authenticity and credibility remains paramount in the ever-evolving professional networking terrain.

### Scenario 5: Content Moderation

A video suddenly emerged on Mayor Harrison's public feed, depicting him seemingly urging citizens to purchase bottled water from his brother's company, citing toxicity in the city's water supply. The video spread like wildfire, fueling public outrage and accusations of nepotism. As the video gained momentum, AI-detection tools raised concerns about its authenticity, suggesting it could be a deep fake. However, the video's quality was so impeccable that even skeptics found it convincing.

Mayor Harrison found himself in a state of shock and disbelief. He vehemently denied making such a statement, suspecting a malicious political scheme. With suspicions jeopardizing his election campaign, he recognized the urgent need to prove his innocence beyond a shadow of a doubt. Seeking a solution, Mayor Harrison's team turned to TrustWrite.ai, renowned for its advanced capabilities. While standard AI-detection had provided a 95% assurance of the video's falseness, they needed a near-certain confirmation to regain the city's trust.

TrustWrite.ai embarked on a meticulous verification process: TrustWrite.ai conducted a thorough examination of the video, scrutinizing details like voice modulation, lip-sync disparities, and nuanced facial expressions that AI might struggle to replicate accurately. The team scoured the archives for equivalent press statements or videos of Mayor Harrison. By comparing these with the controversial video, they highlighted inconsistencies that pointed to manipulation.

In a public setting, Mayor Harrison was asked to replicate specific expressions, utter particular sentences, and engage in spontaneous conversation. This footage was then compared to the deep fake, revealing the subtle disparities between human spontaneity and AI-generated precision. Through this rigorous verification process, TrustWrite.ai succeeded in exposing the video's artificial origins. The comparisons, coupled with Mayor Harrison's genuine reactions, began to sway public opinion.

The aftermath saw the citizens rallying behind Mayor Harrison, applauding his resilience and unwavering integrity. Meanwhile, his political rival faced substantial backlash, both legally and in the court of public opinion. TrustWrite.ai earned recognition for its pivotal role in distinguishing truth from falsehood in an era dominated by digital deceit. This journey underscores the critical significance of advanced verification tools in safeguarding the truth. TrustWrite.ai emerged as a guardian of integrity, ensuring that deep fakes couldn't erode public trust and the foundations of democracy.

### Scenario 6: Image Authenticity

As Vincent, a budding artist with dreams of attaining the stature of legends like Bob Ross, ventured into the world of art, he encountered a unique challenge: Eager to emulate the distinctive style of Bob Ross, Vincent turned to a state-of-the-art AI-art generator capable of replicating it flawlessly. With the AI tool at his disposal, Vincent painstakingly crafted a series of landscape paintings that bore an uncanny resemblance to Bob Ross's iconic style. Filled with optimism, he decided to present these “original” works to a prestigious art gallery.

The art gallery, cognizant of the evolving landscape of art in the digital era, had adopted TrustArt.ai as a safeguard. This specialized tool was designed to identify AI-generated artworks and ensure the authenticity of the pieces they chose to exhibit. During the scrutiny of Vincent's artworks, TrustArt.ai raised initial doubts about their authenticity, detecting patterns characteristic of AI-generated art. To ascertain the genuineness of Vincent's creations, TrustArt.ai initiated a meticulous verification process. This process included a detailed analysis of brush strokes, color gradients, and techniques, comparing them to genuine handcrafted art. Additionally, Vincent was asked to recreate a small section of one of his paintings in real-time, but his attempt lacked the natural fluidity and spontaneity found in authentic artistry. To further assess the authenticity, Vincent faced a knowledge test that quizzed him about specific techniques and choices he had supposedly made in his artwork. Unfortunately, his answers failed to align with the intricacies present in the paintings.

Faced with compelling evidence from TrustArt.ai and Vincent's inability to convincingly defend his work, the art gallery made the difficult decision not to showcase his paintings. They prioritized authenticity over imitation in their selection process. Word spread through the art world about Vincent's endeavor to pass off AI-generated art as his own. While some criticized him for undermining genuine artistic talent, others empathized with the pressures artists face in measuring up to iconic figures. TrustArt.ai received acclaim for its role in preserving the sanctity of original artistry. This journey sheds light on the challenges of preserving authenticity in an era where AI can replicate the brilliance of legendary artists. TrustArt.ai emerges as a protector against the erosion of genuine artistic talent, ensuring that true artistry receives the recognition it rightfully deserves.

### Scenario 7: Audio Authenticity

In the vast digital landscape where songwriters seek to carve their niche and gain recognition, Alex embarked on a journey that would test the boundaries of authenticity: Driven by a desire to leave his mark in the world of music, Alex stumbled upon an AI music generator customized to replicate the unmistakable style of legendary bands, particularly The Beatles. Recognizing the potential of this tool, he harnessed its capabilities to craft a track that flawlessly mirrored the iconic rhythm and melody of the renowned band.

Overflowing with pride in his creation, Alex introduced his “hand-crafted” tune to the digital platform, weaving a narrative of sleepless nights, intricate chord progressions, and heartfelt lyricism that supposedly shaped the song. As the notes of Alex's track resonated through the digital platform, TrustArt.ai, armed with sophisticated algorithms, initiated its review. The system swiftly detected telltale patterns often associated with AI-generated music: repetitive sequences, algorithmically composed harmonies, and the absence of the organic imperfections typically found in human compositions.

Rather than immediately dismissing the submission, TrustArt.ai extended an opportunity to Alex: a verification process designed to authenticate his genuine involvement and unveil the depth of his musical prowess behind the submitted song. Alex faced a series of challenges in this musical quest: He was quizzed about the emotional journey and real-life inspirations that fueled specific lyrical choices and rhythmic patterns. However, his responses were generic and lacked the depth and authenticity expected. He was tasked with composing a short, impromptu piece that had to match the quality and style of the flagged song. Unfortunately, his result lacked the same spark and sophistication.

To further assess his authenticity, he had to elucidate the intricate dynamics, subtle crescendos, and syncopations in his AI-generated track. His explanations wavered between ambiguity and inaccuracy, raising even more doubts. Ultimately, the disparities between Alex's claims and his actual musical knowledge were glaringly evident to TrustArt.ai. It became abundantly clear that the Beatles-inspired song was not a product of his musical genius. As a result, his track faced rejection, ensuring that the digital platform remained a stage for genuine talent. The platform remained steadfast in its commitment to champion human creativity and musical authenticity, with TrustArt.ai serving as a guardian against the influx of AI-generated compositions. It upheld the timeless essence of true music, ensuring that the symphony of the music world continued to resonate with genuine, soulful, and human origins in an era where algorithms could craft catchy beats.

### Scenario 8: Digital Ledger (Register/Share/Exchange)

In a world where AI-generated content proliferates, Samuel embarked on a mission to safeguard the authenticity of his creative work: Months of dedication and passion had gone into crafting a captivating tale, and Samuel believed it to be one of his finest pieces. However, in a landscape inundated with AI-generated stories, he feared that his original work might either get lost amid the digital noise or, worse yet, fall victim to plagiarism. Seeking a reliable means to establish his authorship beyond doubt, Samuel discovered TrustAuthor.ai, a platform meticulously designed to authenticate original content and affirm its human origin.

With hopes of swift validation, Samuel submitted his work to TrustAuthor.ai. However, due to the exceptional sophistication of his writing, the system initially raised a flag, labeling it as “possibly AI-generated.” Unwilling to leave anything to chance, Samuel opted for the “Full Verification” service. His determination was unwavering—he aimed to secure the highest standard of approval for his story, ensuring that it would be unequivocally recognized as an authentic creation.

It delved into the intricate nuances of Samuel's writing, scrutinizing his unique voice, tone, style, and the specific phrasings and idiosyncrasies characteristic of human writers. Samuel was prompted to elucidate various choices he had made in his storyline, character development, and plot twists. His responses, marked by meticulous detail and the undeniable passion inherent in his explanations, left no doubt about his genuine authorship. Upon successfully passing this comprehensive verification, Samuel's work was adorned with the coveted TrustAuthor certification, complete with a unique identification number. This certification, along with his original creation, was securely stored on a public ledger blockchain—an indelible record that solidified the chronology and authenticity of his creative masterpiece.

Armed with his TrustAuthor certification, Samuel submitted his story to a prestigious publisher. A simple query into the TrustAuthor blockchain confirmed Samuel's precedence as the author of the piece. His work wasn't merely accepted; it was celebrated for its originality in a world where true creativity had become a rare gem. In a digital realm overshadowed by AI, TrustAuthor.ai emerged as a guiding light, championing the cause of genuine creators and ensuring that their voices remained distinct and heard. The potent combination of rigorous verification and blockchain technology promised a future where originality would always be recognized, acknowledged, and celebrated. In the future, it is expected that social channels and other on-line platforms will require verification of authenticity (VOA) registration prior to posting or publishing on-line under a content moderation regime.

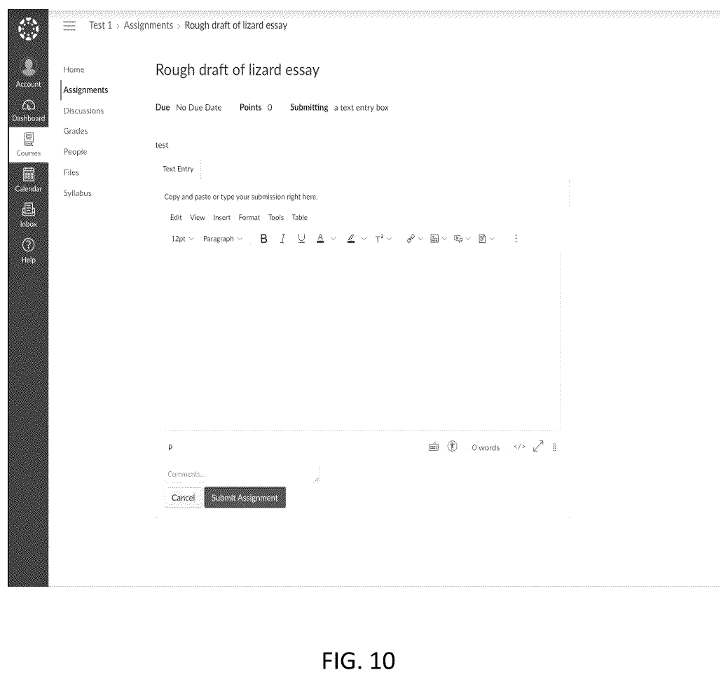

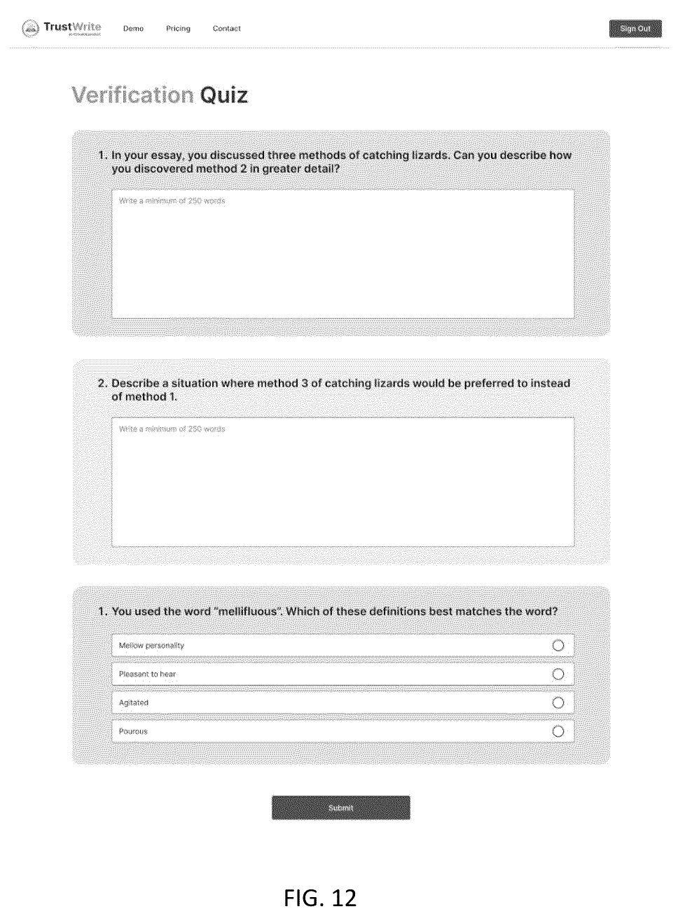

FIG. 10-13 each illustrate an exemplary user interface (U.I) in accordance with an aspect of the invention. FIG. 10 illustrates an exemplary submission page, whereby any one of a student, author, or creator may submit material for submission and review by an authority figure or arbiter. FIG. 11 illustrates an exemplary flagged submission report, featuring a score dashboard, including for a regularity score (perplexity), classifier output score, and style score. Featured to the right of this, is the overall gauge of likelihood of A.I. generation. Finally, a prompt to verify the flagged submission is shown in the right hand corner of the page. FIG. 12 illustrates an exemplary verification page as it would appear to the creator in a proctored environment. FIG. 13 illustrates an exemplary verification score report, featuring a the quiz results from the previous step and a comparative of regularity, classifier, style, and overall verification score results between the submission and the response from the verification step. In the particular scenario highlighted by FIGS. 10-13, the initial flag would appear to be a false positive since the verification mechanism revealed the response scores and risk scores are matched between the submission and response.

While this specification contains many specific execution details, these should not be interpreted as limitations on the scope of any inventions or of what may be claimed, but rather as descriptions of features specific to particular embodiments of particular inventions. Certain features that are described in this specification in the context of separate embodiments can also be implemented in combination in a single embodiment. Contrariwise, various features that are described in the context of a single embodiment can also be implemented and interpreted in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method for detecting and verifying A.I.-generated material, said method comprising the steps of:
receiving a submitted material;
analyzing the received material for attributes characteristic of at least one of an A.I.-generated material or human-generated material;
scoring the analyzed material for a detection score;
flagging the scored material above a pre-defined detection score;
prompting a verification request for at least one submission of a response to at least one of a question or task;
analyzing said response material by referencing against the submitted material for a verification score; and
verifying the authenticity of the submitted material based on the verification score.

2. The method of claim 1, wherein the material is submitted digitally by uploading, downloading, or pasting within a text field.

3. The method of claim 1, wherein the submitted material is analyzed for semantic and/or syntactic perplexity.

4. The method of claim 3, wherein the perplexity analyzed yields a perplexity score.

5. The method of claim 4, wherein the flagged copy with perplexity analysis is passed through a binary classifier for a binary classifier output.

6. The method of claim 5, wherein the flagged copy and classifier output forms at least a portion of a generative A.I. prompt requesting a detection score.

7. The method of claim 1, further comprising a sentiment analysis as part of the generative A.I. prompt requesting a verification score.

9. The method of claim 6, wherein the verification score below a pre-defined score indicates authenticity.

10. The method of claim 1, further comprising the steps of: accessing a historical record of the author's previous submissions; comparing the attributes characteristic of the current submitted material with the historical record; and using the comparison result as an additional metric to verify the authenticity of the submitted material without requiring direct author intervention.

11. A system for detecting and verifying A.I.-generated material, said system comprising:
a processor;
a memory element coupled to the processor;
a program executable by the processor to:
receive a submitted material;
analyze the received material for attributes characteristic of at least one of an A.I.-generated material or human-generated material;
score the analyzed material;
flag the scored material above a pre-defined score;
prompt a verification request for at least one proctored submission of a response to at least one of a question or task;
analyze said response material by referencing against the submitted material for a score; and
verify the authenticity of the submitted material based on the score.

12. The system of claim 11, wherein the material is submitted digitally by uploading, downloading, or pasting within a text field.

13. The system of claim 12, wherein the submitted material is analyzed for semantic and/or syntactic perplexity.

14. The system of claim 13, wherein the perplexity analyzed yields a perplexity score.

15. The system of claim 14, wherein the perplexity score above a pre-defined score yields a flagged material.

16. The system of claim 15, wherein the flagged material with perplexity analysis is passed through a binary classifier for a binary classifier output.

17. The system of claim 16, wherein the flagged material and classifier output forms at least a portion of a generative A.I. prompt requesting a verification score.

18. The system of claim 17, further comprising a sentiment analysis as part of the generative A.I. prompt requesting a verification score.

19. The system of claim 17, wherein the calculated verification score below a pre-defined score indicates authenticity.

20. The system of claim 11, further comprising a user interface that visually presents at least one of an analyzed materials attributes, similarity scores, score ranges, and verification status, enabling users to manually review and override the system's authenticity determination if necessary.

21. The system of claim 20, wherein the user interface provides an option for users to feedback on the accuracy of the detection and/or verification.

22. The system of claim 11, further comprising: an update module executable by the processor, designed to continuously update and refine the database based on newly detected A.I.-generated patterns and feedback from verified human-authored content; and a reinforcement learning module, executable by the processor, that adjusts the scoring, flagging, and verification based on outcomes of past verifications.

23. The system of claim 11, further comprising a feedback loop integrated into the system, allowing users to report instances of perceived bias.

24. The system of claim 11, further comprising a remote proctoring module executable by the processor, configured to initiate real-time video capture of the user as they craft a response for verifying the authenticity of the submitted copy; and an interface tailored to display both the originally submitted copy and the proctored response copy side-by-side for comparative analysis.

25. A system for non-proctored verification of an A.I.-generated material, said system comprising:
a processor;
a memory element coupled to the processor;
a program executable by the processor to:
analyze the received content for a first attribute characteristic of at least one of an A.I.-generated or human generated material;
score the analyzed material based on the first attribute;
flag the scored material above a pre-defined first attribute comparative score;
prompt a verification request for the flagged material; and
verify the authenticity of the flagged material based on analyzing at least a second attribute characteristic different from the first attribute characteristic for deriving a second attribute comparative score.

26. The system of claim 25, wherein the verification of the submitted materials authenticity comprises cross-referencing meta-data associated with the submitted material, including but not limited to timestamps, source IP addresses, and usage patterns.

27. The system of claim 25, wherein the verification request prompted for the flagged material is at least one of a question or task, wherein said question or task is at least one of: knowledge-based, wherein the user is queried on context or content related to the subject matter of the submitted material to determine authenticity; writing-based, wherein the user is tasked with producing a related piece of writing to the submitted material; or evidence-based, wherein the user is prompted to provide sources that validate the content within the submitted material.

28. A method for detecting and verifying A.I.-generated material, said method comprising the steps of:
receiving a submitted material;
analyzing the received material for perplexity and to derive a perplexity score;
forwarding the perplexity analysis to a binary classifier for generating a binary classifier output;
automating a generative A.I. prompt comprising at least the flagged content, perplexity analysis, binary classifier output, and instructions to score a likelihood of being at least one of A.I.-generated or human-generated; and
verifying that the submitted material is A.I.-generated based on the score generated in response to the prompt and a pre-defined threshold.

29. The method of claim 28, further comprising the step of prompting a second verification for at least one proctored submission of a response to at least one of a question or task; analyzing said response copy by referencing against the flagged material against at least one attribute characteristic of at least one of A.I.-generated or human-generated to derive an attribute comparative score; and verifying the authenticity of the flagged material based on the comparative score.

30. The method of claim 28, further comprising generating a unique certification token signifying the authorship authenticity of the submitted material; recording the certification token onto a digital ledger; and allowing entities to at least one of exchange or reference the certification token as proof of the authenticity evaluation of the submitted material.
